(19) United States
(12) Patent Application Publication
(10) Pub. No.: US 2013/0209078 A1
(43) Pub. Date: Aug. 15, 2013

(54) HOT BEVERAGE DISPENSING SYSTEM

(71) Applicant: IMI Cornelius Inc., (US)

(72) Inventors: Sreekanth Pushpala, Bangalore (IN); Xiaofeng Yang, Tianjin City (CN); Min Xu, Tianjin City (CN)

(73) Assignee: IMI CORNELIUS INC, Glendale Heights, IL (US)

(21) Appl. No.: 13/767,059

(22) Filed: Feb. 14, 2013

Related U.S. Application Data
(60) Provisional application No. 61/598,557, filed on Feb. 14, 2012.

(51) Int. Cl. F24H 1/20; B67D 1/08

(52) U.S. Cl. CPC B67D 1/0895
USPC 392/451; 222/146.2

(57) ABSTRACT

A hot beverage dispensing system includes a heat transfer housing having an inner volume. A potable water line is disposed in the heat transfer housing, the potable water line including an inlet and outlet separated from the inner volume of the heat transfer housing. A heat transfer fluid is disposed in the inner volume. A heat source is connected to the inner volume heating the heat transfer fluid. A beverage dispensing mechanism is connected to the outlet of potable water line. The potable water line is separated from the inner volume of the heat transfer housing wherein water within the potable water line is indirectly heated to a predetermined temperature providing a hot water source to the beverage dispensing mechanism.

### CROSS-REFERENCE TO RELATED APPLICATIONS

This application claims priority of U.S. Provisional Application No. 61/598,557 filed Feb. 14, 2012, which is incorporated herein by reference.

### FIELD OF THE INVENTION

The invention relates to a beverage dispensing apparatus including heated beverages.

### BACKGROUND OF THE INVENTION

Beverages may be dispensed through various valves such that fountain drinks and heated beverages may be served to an employee or to a purchaser of a beverage. Generally, heated beverages may be dispensed using water that is heated in a heating mechanism. Often such heated water generates scale and other deposits that require cleaning of the beverage dispensing equipment. Additionally, such heated water may have other undesirable properties due to exposure to a heating system. There is therefore a need in the art for an improved beverage dispensing apparatus that includes a source of potable water that is indirectly heated and does not contact the heating system directly. There is also a need in the art for an improved beverage dispensing system that requires less cleaning and maintenance. There is also a need in the art for a beverage dispensing mechanism that provides a hygienic and heated water source.

### SUMMARY OF THE INVENTION

In one aspect there is disclosed, a hot beverage dispensing system that includes a heat transfer housing having an inner volume. A potable water line is disposed in the heat transfer housing, the potable water line including an inlet and outlet separated from the inner volume of the heat transfer housing. A heat transfer fluid is disposed in the inner volume. A heat source is connected to the inner volume heating the heat transfer fluid. A beverage dispensing mechanism is connected to the outlet of potable water line. The potable water line is separated from the inner volume of the heat transfer housing wherein water within the potable water line is indirectly heated to a predetermined temperature providing a hot water source to the beverage dispensing mechanism.

In another aspect there is disclosed, a hot beverage dispensing system that includes a heat transfer housing having an inner volume. A potable water line is disposed in the heat transfer housing, the potable water line including an inlet and outlet separated from the inner volume of the heat transfer housing. A heat transfer fluid is disposed in the inner volume. A heat source is connected to the inner volume heating the heat transfer fluid. A beverage dispensing mechanism is connected to the outlet of potable water line. The potable water line is separated from the inner volume of the heat transfer housing. A heat transfer circulation line is positioned in the dispensing mechanism. The potable water line is separated from the inner volume of the heat transfer housing wherein water within the potable water line is indirectly heated to a predetermined temperature providing a hot water source to the beverage dispensing mechanism and wherein the outlet of the potable water line is positioned in close proximity to the circulation line maintaining a temperature of the potable water in the dispensing mechanism.

### BRIEF DESCRIPTION OF THE DRAWINGS

FIG. 1 is a schematic representation of a hot beverage dispensing system including a beverage dispensing mechanism;

FIG. 2 is a schematic representation of a hot beverage dispensing system including a separate dispensing mechanism;

FIG. 3 is a schematic representation of a hot beverage dispensing system;

FIG. 4 is a schematic representation of one embodiment of a hot beverage dispensing system including a pressure booster, sacrificial anode, recirculation pump, and dispensing valve;

FIG. 5 is a schematic representation of a recirculation line and dispensing valve including an end view showing a potable water coil and recirculation line disposed in an insulation material;

FIG. 6 is an isometric view of one embodiment of a hot beverage dispensing system with the heat transfer housing removed;

FIG. 7 is an isometric view of a hot beverage dispensing system including the heat transfer housing;

FIG. 8 is a pictorial view of one embodiment of a hot beverage dispensing system;

FIG. 9 is a flow diagram for a control of the hot beverage dispensing mechanism.

### DETAILED DESCRIPTION OF THE EMBODIMENTS

Referring to the figures, there is detailed therein a hot beverage dispensing system 10 that includes an insulated heat transfer housing 12 having an inner volume 14. A potable water line 16 is disposed in the insulated heat transfer housing 12. The potable water line 16 includes an inlet 18 and an outlet 20 that is separated from the inner volume 14 of the insulated heat transfer housing 12. A heat transfer fluid 22 is disposed in the inner volume 14 of the insulated heat transfer housing 12. A heat source 24 is connected to the inner volume 14 heating the heat transfer fluid 22. A beverage dispensing mechanism 26 is connected to the outlet 20 of the potable water line 16 where the potable water line 16 is separated from the inner volume 14 of the insulated heat transfer housing 12 such that water within the potable water line 16 is indirectly heated to a predetermined temperature providing a hot water source to the beverage dispensing mechanism 26.

The hot beverage dispensing system 10 provides an indirect heating of the potable water resulting in a reduced scaling and less frequent cleaning and sanitation activities. The hot beverage dispensing system 10 may use various heat transfer fluids 22 such as filtered water or other suitable heat transfer fluid as may be known in the art.

In one aspect, the hot beverage dispensing system 10 includes a heat source 24 such as a heater which may be electric or otherwise operated. Additionally, the heat source 24 may be an external hot fluid source such as hot water from a heating source such as a dishwasher or other hot water source. In another aspect, the heat source 24 may include heat that is scavenged from a refrigeration system such that hot gas produced in the refrigeration system is utilized to heat the heat transfer fluid 22.

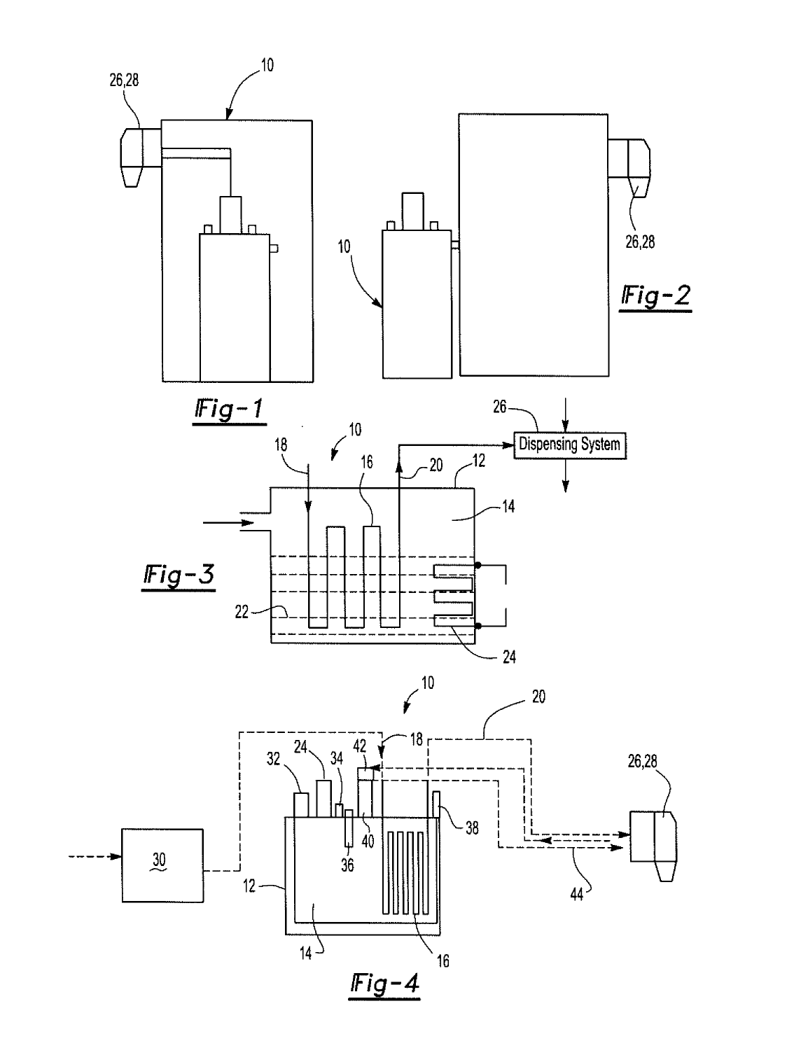

The hot beverage dispensing system 10 may be utilized as a standalone beverage dispensing unit or may be included as an add-on or kit to an existing beverage dispenser. As shown in FIGS. 1 and 2, the hot beverage dispensing system 10 may include a dispensing valve 28 attached to the insulated heat transfer housing 12 as shown in FIG. 1 or the hot beverage dispensing system 10 may be coupled to a separate dispensing mechanism 26, as shown in FIGS. 2 and 8. In one aspect, the beverage dispensing mechanism 26 includes a fountain dispense valve 28 as is known in the art. In one aspect, the fountain dispense valves 28 may include silicone O rings that can be utilized for dispensing and sealing hot fluids.

Referring to FIG. 3, there is shown one embodiment of a hot beverage dispensing system 10. In one aspect, potable water is introduced at a pressure of from 20 to 100 psi or may be boosted as will be described in further detail below. The potable water may be introduced at room temperature or may be preheated through other equipment. In one aspect, the potable water disposed in the potable water supply line 16 may be heated from 5 to 60 degrees centigrade. The potable water line 16 is disposed within the insulated heat transfer housing 12 and is contacting heat transfer fluid 22 disposed within the insulated heat transfer housing 12. In one aspect, the heat transfer media or fluid 22 may be maintained at a specified temperature such as from 70 to 90 degrees centigrade utilizing a heat source 24 which may be electric, gas, or other type of heating element. As the potable water line 16 is immersed or contacting the heat transfer fluid 22 within the insulated heat transfer housing 12, the potable water gets heated to a specified temperature such as from between 50 to 80 degrees centigrade due to an indirect heating. The potable water is then supplied to an outlet 20 that is coupled to a beverage dispenser valve 28 or other suitable dispense outlet.

The indirect heating provides a hygienic way of producing potable hot water as the heating elements are isolated from the potable water. Additionally, the indirect heating reduces scaling and mineral deposits from a water source on the inside of the coils or potable water line 16 which results in less descaling and related maintenance operations.

The dispensing valve 28 may be coupled with various syrups or flavorings to form a hot beverage. Various beverage dispense subsystems including a syrup delivery and syrup to hot water ratio controls may be utilized. Such subsystems may be included as a portion of the hot beverage dispensing system 10 or, in the case where the hot beverage dispensing system 10 is coupled to an existing beverage dispenser, such assembly may already be provided.

Referring to FIG. 4, there is shown one embodiment of a hot beverage dispensing system 10. In the detailed embodiment, the potable water inlet 18 is coupled to a booster mechanism 30 that increases a pressure of the water in the potable water line 16 to a predetermined amount. In one aspect, the water may be boosted to a pressure of from 60 to 100 psi. This high pressure potable water then flows into the potable water line 16. Various other mechanisms may be included in the hot beverage dispensing system 10 as shown in FIG. 4. For example, a temperature controller 32 controlling the temperature of the heat transfer fluid 22 and potable water may be provided. Additionally, a pressure relief valve 34 may be attached to the insulated heat transfer housing 12 allowing release of steam or pressure within the insulated heat transfer housing 12. Further, a sacrificial anode 36 may be disposed in the inner volume 14 of the insulated heat transfer housing 12 thereby reducing scaling when water is utilized as a heat transfer fluid 22. An automatic level controller 38 may be provided that maintains the heat transfer fluid 22 at a desired level. The level controller 38 may also act as a safety device by shutting off power when heat transfer fluid 22 falls below a specified value.

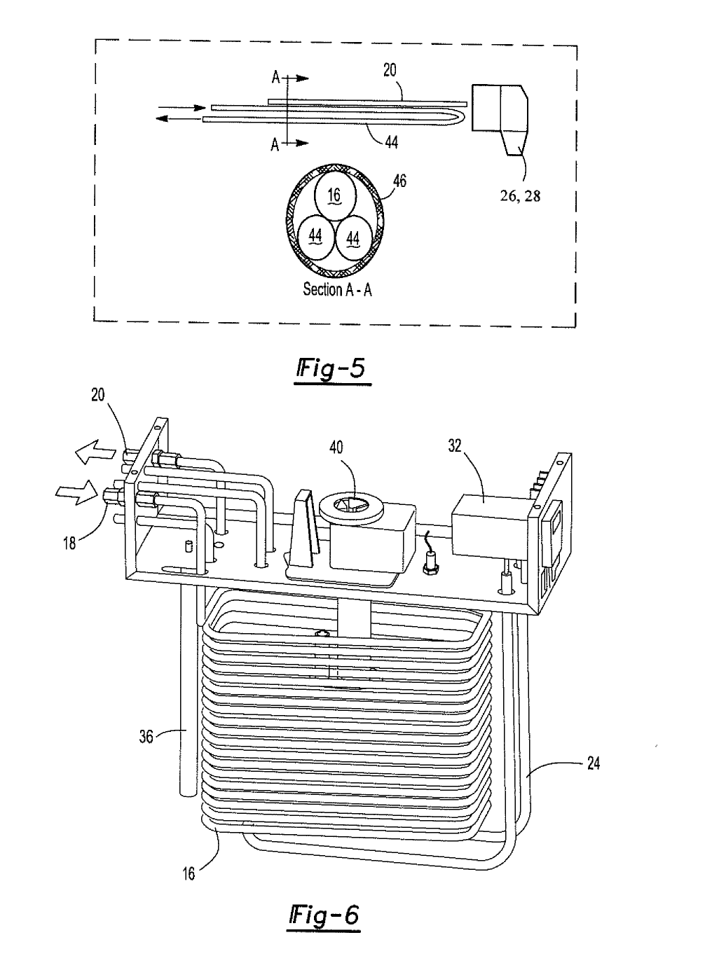

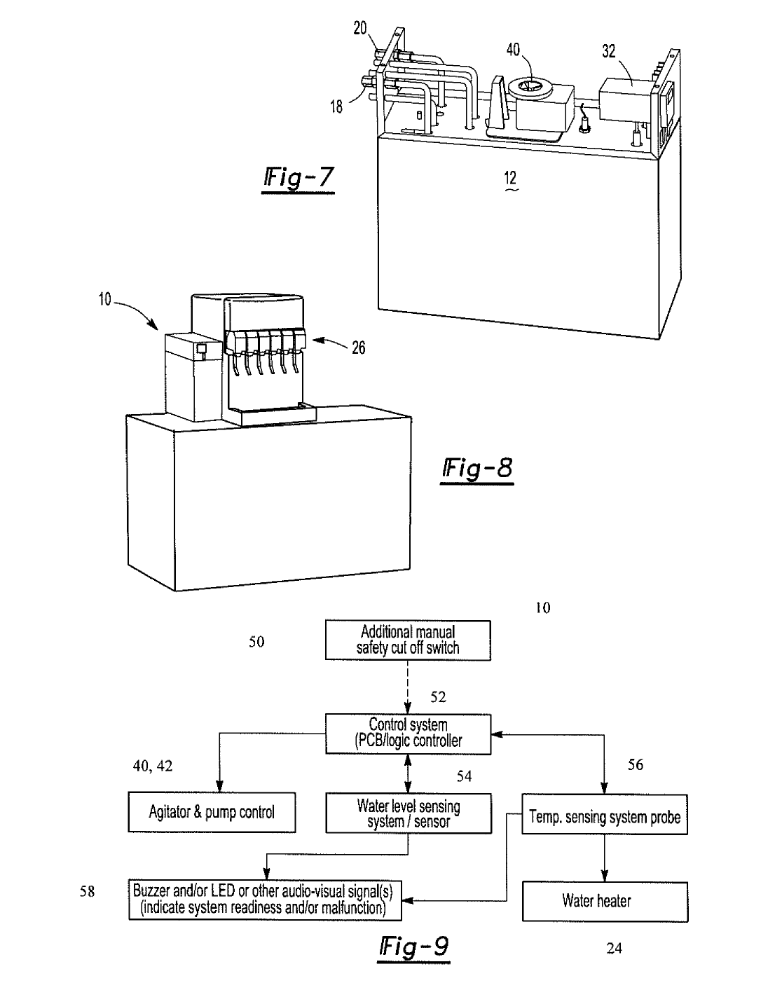

As can also be seen in FIGS. 4 and 7-8, an agitator 40 may be disposed in the inner volume 14 to disperse the heat transfer fluid 22 uniformly within the inner volume 14 of the insulated heat transfer housing 12. In the depicted embodiment, the agitator 40 may also include a recirculation pump 42 in combination with a motor of the agitator 40. The recirculation pump 42 may be connected to a heat transfer circulation line 44. The heat transfer circulation line 44 may be positioned within the dispensing mechanism 26. In one aspect, the outlet 20 of the potable water line 16 is positioned in close proximity as best shown in FIG. 5 to the circulation line 44 maintaining a temperature of the potable water within the dispensing mechanism 26. In one aspect, the circulation line 44 and outlet 20 of the potable water line 16 may be bundled in a thermal insulation layer 46 to maintain a temperature of the fluid or water within the dispense mechanism 26. The hot media or fluid recirculation helps to ensure that the drink temperature is maintained when a dispense mechanism 26 has been idle for a period of time and to ensure that the drink temperature is within specified limits.

In use, the hot beverage dispensing system 10 may be included as a standalone unit that has a dispensing valve 28 connected to the system or it may be attached as a kit to an existing beverage dispenser. Potable water is introduced into a water line 16 that is disposed within an insulated heat transfer housing 12 having an inner volume 14. Heat transfer fluid 22 is disposed within the inner volume 14 and is heated to a specified temperature such as from between 70 to 90 degrees centigrade using a heat source 24. The potable water passes through the potable water line 16 and is indirectly heated by the heat transfer fluid 22 to a specified temperature such as between 50 degrees centigrade and 80 degrees centigrade. The heated potable water exits at an outlet 20 of the potable water line 16 into a dispensing mechanism 26. As specified above, the dispensing mechanism 26 may be separate from or attached to the hot beverage dispensing system 10. The potable water exiting may be combined with various flavorings or syrups in the dispensing valve 28 to provide a hot beverage. The heat transfer fluid 22 may be recirculated through the recirculation pump such that the circulation line 44 is in close proximity to an outlet 20 of the potable water line 16. In this manner, potable water within the dispense valve 28 is maintained at a specified temperature when the dispensing valve 28 has been idle for a period of time.

Referring to FIG. 9 there is shown a control flow diagram of the hot beverage dispensing system 10. As can be seen in the figure, the control may include a manual switch 50 to turn on the hot beverage dispensing system 10. A control system or computer controller 52 is connected to the various mechanical components of the system including the agitator 40 and pump 42, water level sensor 54, temperature sensor 56, heater or heat source 24, and an output device 58 such as an led or audio output device to signal various states of the system. The computer controller 52 monitors the various parameters detected by the sensors and maintains the water level and temperature of the potable water and heat transfer media. The computer controller 52 also activates the various output devices 58 to let a user know the current status of the system and to alert a user to a specific condition such as a low water level or incorrect temperature.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

We claim:

1. A hot beverage dispensing system comprising:
a heat transfer housing having an inner volume;
a potable water line disposed in the heat transfer housing, the potable water line including an inlet and outlet separated from the inner volume of the heat transfer housing;
a heat transfer fluid disposed in the inner volume;
a heat source connected to the inner volume heating the heat transfer fluid;
a beverage dispensing mechanism connected to the outlet of potable water line;
wherein the potable water line is separated from the inner volume of the heat transfer housing wherein water within the potable water line is indirectly heated to a predetermined temperature providing a hot water source to the beverage dispensing mechanism.

2. The hot beverage dispensing system of claim 1 wherein the heat source includes a heater.

3. The hot beverage dispensing system of claim 1 wherein the heat source includes an external hot fluid source.

4. The hot beverage dispensing system of claim 1 wherein the heat source includes heat scavenged from a refrigeration system.

5. The hot beverage dispensing system of claim 1 wherein the dispensing mechanism is connected to the heat transfer housing.

6. The hot beverage dispensing system of claim 1 wherein the beverage dispensing mechanism includes a fountain dispense valve including silicone O rings.

7. The hot beverage dispensing system of claim 1 wherein the dispensing mechanism is separate from the heat transfer housing.

8. The hot beverage dispensing system of claim 1 including a booster mechanism connected to the potable water inlet increasing a pressure of water in the potable water line to a predetermined pressure.

9. The hot beverage dispensing system of claim 1 including a temperature controller controlling the temperature of the heat transfer fluid and potable water.

10. The hot beverage dispensing system of claim 1 including a pressure relief valve attached to the heat transfer housing.

11. The hot beverage dispensing system of claim 1 including a sacrificial anode disposed in the inner volume reducing scaling.

12. The hot beverage dispensing system of claim 1 including an agitator disposed in the inner volume, the agitator dispersing the heat transfer fluid uniformly.

13. The hot beverage dispensing system of claim 1 including a heat transfer fluid level controller controlling a level of the heat transfer fluid within the inner volume.

14. The hot beverage dispensing system of claim 1 including a recirculation pump.

15. The hot beverage dispensing system of claim 14 wherein the recirculation pump is in combination with a motor of the agitator.

16. The hot beverage dispensing system of claim 14 wherein the recirculation pump is connected to a heat transfer circulation line.

17. The hot beverage dispensing system of claim 16 wherein the heat transfer circulation line is positioned in the dispensing mechanism.

18. The hot beverage dispensing system of claim 17 wherein the outlet of the potable water line is positioned in close proximity to the circulation line maintaining a temperature of the potable water in the dispensing mechanism.

19. The hot beverage dispensing system of claim 18 wherein the circulation line and outlet of the potable water line are bundled in a thermal insulation cover.

20. A hot beverage dispensing system comprising:
a heat transfer housing having an inner volume;
a potable water line disposed in the heat transfer housing, the potable water line including an inlet and outlet separated from the inner volume of the heat transfer housing;
a heat transfer fluid disposed in the inner volume;
a heat source connected to the inner volume heating the heat transfer fluid;
a beverage dispensing mechanism connected to the outlet of potable water line;
a heat transfer circulation line positioned in the dispensing mechanism;
wherein the potable water line is separated from the inner volume of the heat transfer housing wherein water within the potable water line is indirectly heated to a predetermined temperature providing a hot water source to the beverage dispensing mechanism and wherein the outlet of the potable water line is positioned in close proximity to the circulation line maintaining a temperature of the potable water in the dispensing mechanism.
